(19) United States
(12) Patent Application Publication
(10) Pub. No.: US 2025/0258842 A1
(43) Pub. Date: Aug. 14, 2025

(54) UTILIZING A FEATURE EXTRACTION FUNCTION WITHIN A DIGITAL SEARCH PLATFORM

(71) Applicant: Dropbox, Inc., San Francisco, CA (US)

(72) Inventors: Yi Bo Yun, Bellevue, WA (US); Girish Jeyakumar, Redmond, WA (US)

(21) Appl. No.: 18/439,525

(22) Filed: Feb. 12, 2024

(51) Int. Cl. G06F 16/28; G06F 16/242

(52) U.S. Cl. CPC G06F 16/287; G06F 16/2428

(57) ABSTRACT

This disclosure describes embodiments of systems, methods, and non-transitory computer readable storage media that can enable integration of functionalities for a content item search platform within a search platform prototyping tool. For example, the disclosed systems can utilize a search platform prototyping tool that enables a quick selection of a feature extraction function (or component). Based on the selected feature extraction function, the disclosed systems can prototype the feature extraction function on live data of a content management system to emulate a fully onboarded implementation of the feature extraction function (as a new functionality) on a search platform. Moreover, the disclosed systems can also display, within a search platform graphical user interface, selectable elements to display consolidated metadata associated with search results within a single user interface.

### BACKGROUND

Recent years have seen increasing utilization of online search platforms in online or “cloud” storage systems that store and manage content items generated via client devices. For example, existing content management systems provide tools for users to create, modify, delete, and share electronic media within an online or “cloud” storage system. Furthermore, existing content management systems often provide search functionalities to search and retrieve content items stored on the online or “cloud” storage system. In many cases, existing content management systems also facilitate development tools to debug search platform features and to implement new functionalities within a search platform of existing content management systems. Despite such existing content management systems providing development tools to debug search functionalities and deploy new search functionalities, these existing systems often provide inefficient and inflexible development tools that require time intensive and prohibitive interactions to debug search functionalities and implement new search functionalities.

For example, many existing content management systems facilitate inefficient development tools. To illustrate, many existing content management systems facilitate development tools that require developers to utilize extensive coding to build or create a new functionality and a data pipeline framework (e.g., data dispatchers, listeners, file system dependencies, dependencies and services of the new functionality) to deploy the new functionality. Oftentimes, such development tools are time intensive. To illustrate, in many cases, to code new functionality and a data pipeline framework for the new functionality requires months or weeks. In addition to creating the new functionality and the data pipeline framework, existing development tools on content management systems require intensive time (e.g., weeks, months) to deploy and integrate the new functionality and data pipeline framework within the content management system. Accordingly, many existing content management systems facilitate inefficient development tools that slow down deployment and integration of new functionalities within an existing content item search platform.

Furthermore, in many cases, existing content management systems facilitate development tools that are inflexible. For instance, without fully deploying and integrating the new functionalities (via time intensive coding and development), existing content management system development tools are often unable to facilitate testing of the new functionality on live versions of content management systems. In particular, in many cases, existing content management systems require shutting down or restricting access to systems during deployment and integration of new functionalities on content item search platforms. This often requires frequent server downtime and inflexible, limited testing of new functionalities on the content item search platforms.

As a result of inefficient and inflexible development tools that cause slow and limited integration of new functionality within existing content item search platforms, existing content management systems often facilitate outdated, inaccurate search platforms. For example, existing search platforms often do not frequently receive new functionalities and/or bug fixes as a result of the slow and limited integration via existing development tools. As such, in many cases, existing content management systems are unable to provide up-to-date and accurate content items search results.

Additionally, many existing content management systems provide inefficient development user interfaces for debugging search platforms of the existing content management systems. For instance, upon identifying a bug (or other technical deficiency) within a search platform, existing development tools often require developers to navigate between multiple databases, user interfaces, development documentation, and/or other systems that display information on search results and/or search queries to investigate root causes of the bug (or other technical deficiency). This often requires an inefficient amount of navigation between various user interfaces and systems which results in inefficient utilization of processing power, time, and bandwidth of development tools to debug existing search platforms.

### SUMMARY

This disclosure describes one or more embodiments of systems, computer-implemented methods, and non-transitory computer readable storage media that provide benefits and/or solve one or more of the foregoing and other problems in the art. In particular, the disclosed systems enable efficient and flexible integration of new functionalities for a content item search platform within a search platform prototyping tool. For example, the disclosed systems can utilize a search platform prototyping tool that enables a quick selection of a feature extraction function (or component). Based on the selected feature extraction function, the disclosed systems can efficiently and easily prototype the feature extraction function on live data of a content management system to emulate a fully onboarded implementation of the feature extraction function (as a new functionality) on a search platform. Moreover, the disclosed systems can also display, within a search platform graphical user interface, selectable elements to display extensive metadata associated with search results within a single user interface to facilitate debugging without user navigation between multiple user interfaces.

### BRIEF DESCRIPTION OF THE DRAWINGS

The detailed description is described with reference to the accompanying drawings in which:

FIG. 1 illustrates a schematic diagram of an example system in which a search platform prototyping system operates in accordance with one or more implementations.

FIG. 2 illustrates an exemplary workflow of the search platform prototyping system integrating a feature extraction component into a content item search platform in accordance with one or more implementations.

FIG. 3 illustrates a search platform prototyping system deploying and integrating one or more feature extraction components with a content item search platform in accordance with one or more implementations.

FIG. 4 illustrates a search platform prototyping system displaying a content item modification function based on labels from a feature extraction component in accordance with one or more implementations.

FIG. 5 illustrates a search platform prototyping system displaying output data of one or more feature extraction components as part of content item search results in accordance with one or more implementations.

FIG. 6 illustrates a search platform prototyping system displaying consolidated metadata for a content item search result within a search platform in accordance with one or more implementations.

FIG. 7 illustrates a search platform prototyping system facilitating one or more search query builder options within a graphical user interface for a search query prompt in accordance with one or more implementations.

FIG. 8 illustrates a flowchart of a series of acts for integrating feature extraction functionalities within a content item search platform in accordance with one or more implementations.

FIG. 9 illustrates a block diagram of an exemplary computing device in accordance with one or more implementations.

FIG. 10 illustrates an example environment of a networking system in accordance with one or more implementations.

### DETAILED DESCRIPTION

This disclosure describes one or more embodiments of a search platform prototyping system that provides a flexible and efficient search platform prototyping tool that enables quick deployment of a feature extraction function for a search platform to emulate search results using the feature extraction function on the search platform. To illustrate, the search platform prototyping system can identify a feature extraction component that is selected for integration within a searchable content management system. In addition, the search platform prototyping system can deploy the selected feature extraction component to automatically assign labels (or other feature extraction data) on content items within the content management system (e.g., via backfilling). Moreover, the search platform prototyping system can utilize the assigned labels to retrieve content items within the search platform to emulate (as a prototype) the feature extraction functionality within the search platform. Also, the search platform prototyping system can display, as part of the search results, metadata (e.g., metadata from multiple sources, class labels, multiple identifiers) consolidated within the single search platform search result interface.

As mentioned above, the search platform prototyping system can facilitate a flexible and efficient prototyping of feature extraction functions on a search platform. For instance, the search platform prototyping system can deploy a selected feature extraction function to perform a feature extraction on (live) content items within a searchable content management system. In particular, the search platform prototyping system can receive (e.g., via a selection, upload, or transmission from a feature extraction system) a feature extraction function (e.g., an image classification, a text classification function, a video tagging function). Moreover, the search platform prototyping system can utilize the feature extraction function to perform a feature extraction (e.g., classification labeling, tagging, or other feature extraction task) on (live) content items within a searchable content management system to generate and associate labels (or other feature extraction data) with the content items (e.g., via backfilling and/or indexing).

In addition, the search platform prototyping system can emulate full deployment of the selected feature extraction function (as a prototype) in a search platform via the assigned labels (or other feature extraction data). For instance, the search platform prototyping system can receive a search query within a search platform (e.g., via a developer account or developer interface) and search for content items on the searchable content management system using the search query. As an example, the search platform prototyping system can identify matches between the search query and one or more of the labels assigned to the content items (via the selected feature extraction function) to display content items as search results. Indeed, the search platform prototyping system can enable searching for the added labels to display the content item search results within a developer user interface to prototype (or test) the search platform with the selected feature extraction function.

Furthermore, the search platform prototyping system can display extensive metadata associated with search results within a single user interface to facilitate debugging without user navigation between multiple user interfaces. In particular, the search platform prototyping system can identify various metadata (e.g., metadata from multiple sources, class labels, multiple identifiers) and consolidate the metadata for the content items. In addition, the search platform prototyping system can display, within a search platform user interface, one or more selectable elements associated with the content item search results that, upon user interaction, display metadata associated with a particular content item in the content item search results. Indeed, the metadata can indicate identifiers associated with the content item, names associated with the content item, file name information associated with the content item, and/or class labels from various feature extraction functions implemented within the content management system. In one or more instances, the search platform prototyping system can display metadata, from multiple sources, associated with an individual content item in a search result user interface (as a developer tool) to enable an administrator to retrieve the metadata without having to navigate between multiple user interfaces that manage different metadata for the content item.

In some instances, the search platform prototyping system can also enable one or more selectable user interface elements for search query building tools within the search platform of the content management system. For example, the search platform prototyping system can display one or more selectable search query builder options that enable a selection of various query configurations, such as, but not limited to, selectable label types, selectable search query APIs, and/or selectable identifier types for the content items. Indeed, the search platform prototyping system can receive a selection one or more search query builder options to focus a search via a search query with a particular set of metadata and/or a particular information source. For example, the search platform prototyping system can utilize selected search query builder options (e.g., a particular selected class label and a particular identifier type) to focus a search query-based search to search for the particular selected labels and/or identifier types.

The search platform prototyping system provides several technical advantages over existing systems. For example, the search platform prototyping system provides efficient and flexible development tools to integrate new functionalities for content item search platforms that build accurate search platforms. Indeed, unlike conventional systems that require developers to utilize time intensive approaches to code and build new functionalities and data pipeline frameworks to integrate the new functionalities within a search platform, the search platform prototyping system can efficiently integrate and deploy new functionalities into existing search platforms of content management systems.

To illustrate, the search platform prototyping system can receive simple selections (or uploads) of feature extraction components (e.g., image classifiers, text classifiers for specific tasks) and directly prototype the feature extraction components on existing content items in an existing content item search platform without development of a data pipeline framework or server downtime. For instance, the search platform prototyping system can deploy the selected feature extraction component to automatically assign labels on content items within the content management system (e.g., via backfilling and/or indexing). Then, the search platform prototyping system can enable search platform searches (e.g., in a development environment) on the content items based on the labels created from the newly introduced feature extraction tool. By doing so, the search platform prototyping system can enable quick and efficient deployment and integration of feature extraction components in an existing search platform without inefficient integration and deployment processes and framework development that require weeks or months to develop, integrate, and/or deploy.

In addition, unlike the inflexibilities of existing development tools for content item searches, the search platform prototyping system improves the flexibility of development (or prototyping) tools for search platforms. In particular, due to the above-mentioned improvements in speed in integration and deployment of feature extraction components in existing search platforms, the search platform prototyping system also improves the flexibility of deploying and testing new functionalities on live versions of content management systems. For example, the search platform prototyping system can enable easy and quick deployment of feature extraction components on an existing search platform (of a content management system) without time intensive development and without shutting down (or restricting access) to systems during the deployment and integration of the new functionality. Accordingly, the search platform prototyping system can enable flexible deployment and testing of various types and versions of feature extraction components in a live searchable content management system environment.

Furthermore, due to the efficiencies and flexibilities described above, the search platform prototyping system also improves the accuracy of search platforms. More specifically, the search platform prototyping system increases the speed at which new feature extraction functionalities are introduced, tested, and deployed on live search platforms. As such, the search platform prototyping system facilitates an increased number of introduced feature extraction functions, version updates, and bug fixes on a search platform to provide up-to-date and accurate content item search results.

In one or more embodiments, the search platform prototyping system provides a development tool that enables a developer user to utilize simpler coding functions to prototype feature extraction components on a content item search platform. Indeed, the search platform prototyping system 106 can integrate the prototype feature extraction component on live content items in a content management system to enable a development prototyping experience that emulates the experience of a fully onboarded use case of the feature extraction component on the content item search platform. In addition, as mentioned-above, the search platform prototyping system 106 provides a development tool that includes a retrieval user interface that enables developer users to directly view metadata of retrieved content items and/or run search retrievals on specific namespaces.

As illustrated by the foregoing discussion, the present disclosure utilizes a variety of terms to describe features and benefits of the search platform prototyping system. Additional detail is now provided regarding the meaning of these terms. As used herein, the term “content” (or sometimes referred to as “content item,” “content,” “media content file,” “digital content,” or “media content”) refers to discrete data representation of a document, file, image, video, or other types of content. In particular, a digital content item can include, but is not limited to, a digital image (file), a digital video (file), an electronic document (e.g., text file, spreadsheet, PDF, forms), and/or electronic communication (e.g., one or more instant messages, e-mails).

As further used herein, the term “feature extraction component” (sometimes referred to as “feature extraction function”) refers to a collection of instructions (or code) that implements a computer representation (or model) to analyze data and draw inferences (e.g., feature extraction data) from the data. For example, a feature extraction component can include an implementation of one or more machine learning models that perform particular feature extraction tasks (e.g., classification tasks, feature extraction tasks) on content items. For instance, a feature extraction component can include an implementation of a machine learning model that generates feature extraction data, such as, but not limited to, classifications (or labels) images based on subjects detected in the images, classifications (or labels) text with classes or categories, and/or extracted exchangeable image file format (EXIF) data for images. Moreover, a feature extraction component can include an implementation of a machine learning model (or other feature extraction model) configured by one or more developers, uploaded from a development environment, and/or selected from a repository of existing feature extraction programs and/or applications.

Furthermore, as used herein, the term “machine learning model” refers to a computer representation that can be tuned (e.g., trained) based on inputs to approximate unknown functions. Indeed, a machine learning model can refer to a computer representation that can be tuned (e.g., trained) based on inputs to determine classifications for particular data, generate particular data, and/or generate inferences from particular data. For example, a machine learning model can refer to a computer representation that can be tuned (e.g., trained) based on inputs to analyze text and/or images. As an example, a machine learning model can be adjusted or trained to analyze images to determine classifications or labels for subjects depicted within the images. In some cases, a machine learning model can be tuned (e.g., trained) to analyze text (e.g., documents) to determine vector embeddings and/or categories for the analyzed text.

For instance, a machine learning model can include, but is not limited to, a differentiable function approximator, a contrastive language-image pre-training model, a neural network (e.g., a convolutional neural network, deep learning model, recurrent neural network, generative adversarial neural network), a decision tree (e.g., a gradient boosted decision tree), a linear regression model, a logistic regression model, a clustering model, association rule learning, inductive logic programming, support vector learning, Bayesian network, regression-based model, principal component analysis, or a combination thereof.

Additionally, as used herein, the term “classification model” (or sometimes referred to as “classifier”) refers to a machine learning model that can be tuned (e.g., trained) to analyze images, video frames, and/or documents (e.g., text documents, spreadsheets) to determine classifications, categories, and/or labels for content portrayed and/or described in the images, video frames, and/or documents.

In one or more implementations, a classification model can include an image classification model. In some cases, the term “image classification model” refers to a machine learning model that can be tuned (e.g., trained) to determine classifications for the content portrayed within the images (or video frames). For instance, an image classification model can determine classifications for content portrayed within the images (or video frames), such as, but not limited to, places, objects, actions, emotions, people, mood, camera angles, image quality, perspective, and/or landscape versus portrait. In one or more embodiments, a feature extraction component can include various image classification models, such as, but not limited to, convolution neural network-based image classifiers and/or recurrent neural network-based image classifiers.

In some cases, a classification model can include a text classification model. For example, the term “text classification model” refers to a machine learning model that can be tuned (e.g., trained) to determine categories for content described within text (or text documents). For instance, a text classification model can determine categories for content described within text (or text documents), such as, but not limited to, places, objects, actions, people, and/or topics. In one or more embodiments, a feature extraction component can include various text classification models, such as, but not limited to, convolution neural network-based text classifiers and/or recurrent neural network-based text classifiers.

As used herein, the term “feature extraction data” refers to output data of a feature extraction component. For instance, feature extraction data can include inferenced or predicted output data of a feature extraction component from input data. To illustrate, feature extraction data can include, but is not limited to, labels, tags, EXIF data, text descriptions, and/or feature vectors.

As used herein, the term “label” (sometimes referred to as “classification label” or “tag”) refers to an indicator for a categorical or classification of content. In particular, a label can include an indicator (e.g., a tag, metadata, text) that indicates a content item as belonging to a particular category or classification (e.g., to represent what is depicted or described in the content item). For example, a label can include, but is not limited to, an indicator that identifies content portrayed within content (e.g., food, cars, persons) and/or categories in which the content belongs (e.g., bank document, school document, medical document). In one or more instances, the search platform prototyping system can utilize a feature extraction component (e.g., a component implementing a machine learning model, such as an image classification model, a text classification model, and/or a key phrase extraction model) to generate labels (and label classification probabilities) for content items. In some instances, a label can include an image content recognition label and/or a key phrase extraction label.

As further used herein, the term “label classification probability” (sometimes referred to as “classification score” or “label classification score”) refers to a value that indicates a likelihood (or confidence) of a classification output by a machine learning model. In particular, a label classification probability can include a confidence value that indicates the likelihood of a label belonging to a content item (e.g., 10% confidence, 20% confidence, 90% confidence). For example, a machine learning model can generate (or determine) a label classification probability (e.g., a confidence score) for a classification determination. In addition, as further used herein, the term “metadata” refers to data that provides information on one or more attributes (or aspects) of a content item or a file corresponding to the content item. For instance, metadata can include information, such as, but not limited to, a creation time, a file size, a modification time, camera information, file name, and/or database identifiers. In some cases, metadata for a content item can include information, such as, but not limited to, classification labels, label classification probabilities, and/or information on the feature extraction components utilized on the content item (e.g., feature extraction component data objects).

Moreover, as further used herein, the term “content item modification function” refers to a set of instructions (or code) that causes a modification of or action towards a content item. For example, a content item modification function can modify content items to change visual traits of the content item (e.g., colors, textures, styles), image settings (e.g., exposure, brightness, saturation, contrast, shadow), file attributes (e.g., formatting styles, file types), and/or audio settings (e.g., adding or removing sound effects, sound balance, adding or removing music). As an example, a content item modification function can include, but is not limited to, a function that modifies images to depict a modified style (e.g., in a cartoon style, a painting style), modifies a document (e.g., changes font styles, font size, spreadsheet themes), and/or modifies sound (e.g., censors particular words in audio, emphasizes audio of particular subject).

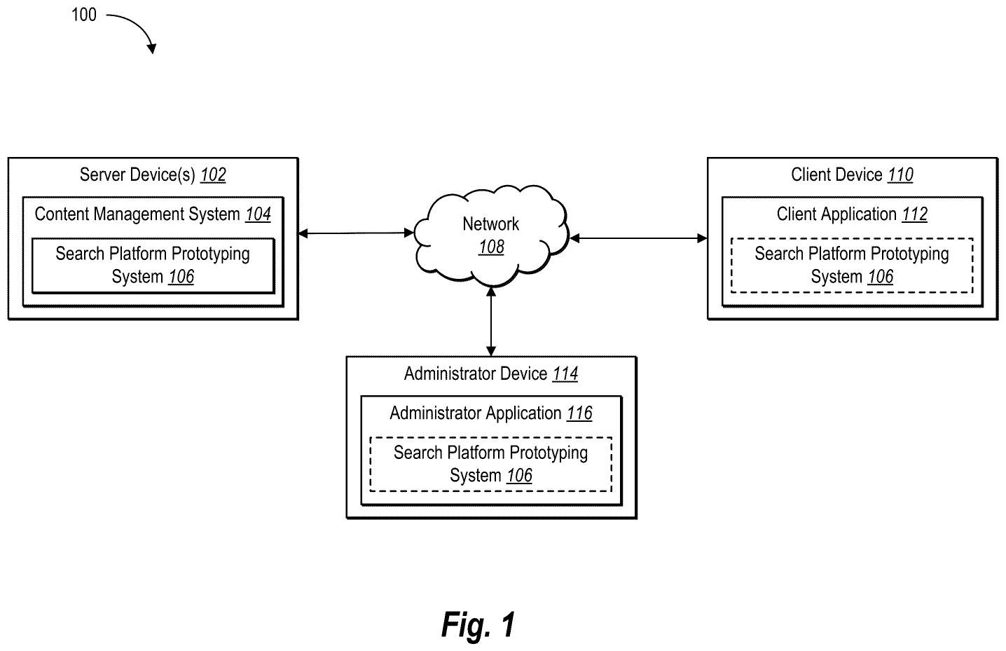

Turning now to the figures, FIG. 1 illustrates a schematic diagram of one implementation of a system 100 (or environment) in which a search platform prototyping system 106 operates in accordance with one or more implementations. As illustrated in FIG. 1, the system 100 includes server device(s) 102, a network 108, a client device 110, and an administrator device 114. As further illustrated in FIG. 1, the server device(s) 102, the client device 110, and the administrator device 114 communicate via the network 108.

As shown in FIG. 1, the server device(s) 102 include a content management system 104, which further includes the search platform prototyping system 106. In particular, the content management system 104 provides functionality by which a user (not shown in FIG. 1) can use the client device 110 to generate, manage, and/or store digital content. For example, a user can generate digital content using the client device 110. Subsequently, a user utilizes the client device 110 to send the digital content to the content management system 104 hosted on the server device(s) 102 via the network 108. The content management system 104 can then provide many options that the client device 110 may utilize (and a user selects or otherwise interacts with) to store the digital content, organize the digital content, share the digital content, and subsequently search for, access, view, and/or modify the digital content.

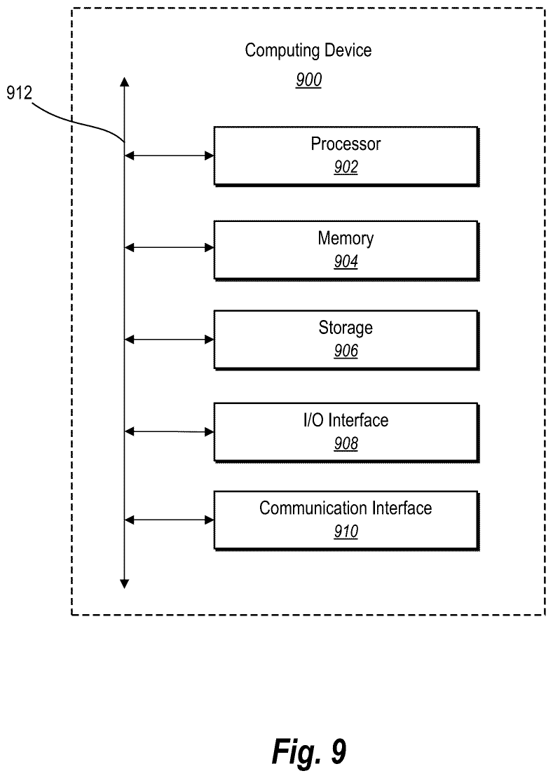

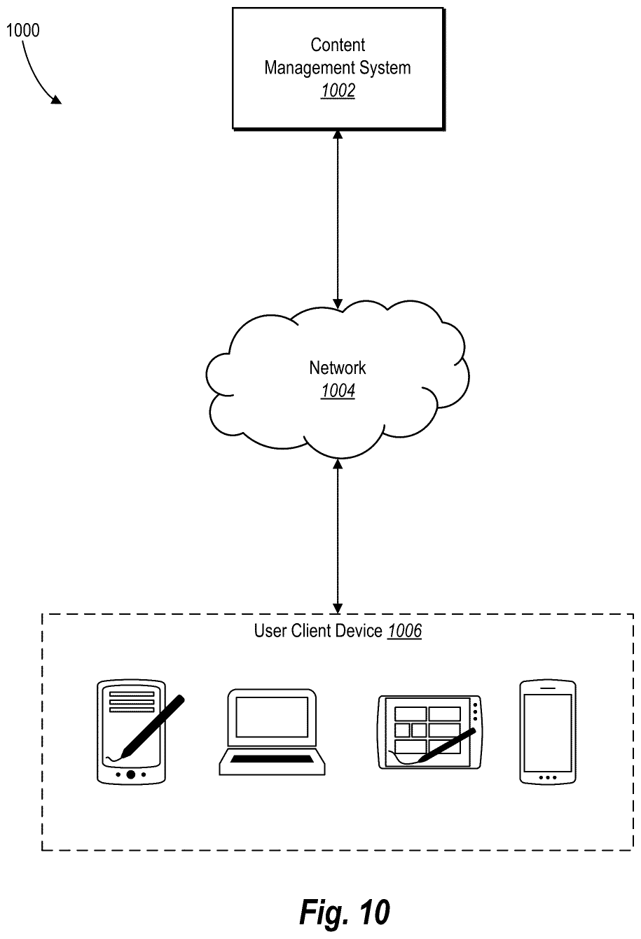

In addition, the content management system 104 provides a content search platform that enables a user to, via search query prompts, search for various digital content items corresponding to the user account of the user. For example, the content management system 104 can receive a search query prompt in a content search platform of the content management system 104. Subsequently, the content management system 104 can utilize the search query prompt and metadata (or content) of content items corresponding to a user account to surface one or more relevant content items for the search query prompt. Additional detail regarding the content management system 104 is provided below (e.g., in relation to FIG. 10 and the content management system 1002). Furthermore, the server device(s) 102 can include, but are not limited to, a computing (or computer) device (as explained below with reference to FIG. 9.

As also shown in FIG. 1, the server device(s) 102 include the search platform prototyping system 106 (through the content management system 104). For instance, the search platform prototyping system 106 can enable integration of feature extraction components in a content item search platform of the content management system 104. Indeed, the search platform prototyping system 106 can prototype a feature extraction component on live data of the content management system 104 to emulate a fully onboarded implementation of the feature extraction component on the search platform (in accordance with one or more implementations herein). Moreover, the search platform prototyping system 106 can also display, within a search platform graphical user interface, selectable elements to display extensive metadata associated with search results.

As further shown in FIG. 1, the system 100 includes the client device 110. In one or more implementations, the client device 110 include, but are not limited to, mobile devices (e.g., smartphones, tablets), laptops, desktops, or other types of computing devices, as explained below with reference to FIG. 9 For example, the client device 110 can be operated by users to perform various functions (e.g., via the client application 112 as a content management system application) such as, but not limited to, creating, receiving, viewing, modifying, and/or transmitting digital content, utilizing search query prompts in a content search platform, configuring user account or application settings of the content management system 104, and/or electronically communicating with other user accounts of the content management system 104 via electronic communications. Although FIG. 1 illustrates a single client device 110, in one or more embodiments, the system 100 can include various numbers and types of client devices.

To access the functionalities of the content management system 104 (and the search platform prototyping system 106), a user can interact with the client application 112 (e.g., a content management system application) via the client device 110. The client application 112 can include one or more software applications installed on the client device 110. In some implementations, the client application 112 can include one or more software applications that are downloaded and installed on the client device 110 to include an implementation of the search platform prototyping system 106. In some embodiments, the client application 112 is hosted on the server device(s) 102 and is accessed by the client device 110 through a web browser and/or another online platform. Moreover, the client application 112 can include functionalities to access or modify a file storage structure stored locally on the client device 110 and/or hosted on the server device(s) 102.

In some cases, a user can interact with the client application 112 to access functionalities of the search platform prototyping system 106. In particular, the client application 112 can receive (or identify) one or more feature extraction components from the client device 110 (or user interactions on the client device 110). Then, the search platform prototyping system 106 can integrate the feature extraction component within the content search platform of the content management system 104 (in accordance with one or more implementations herein) (e.g., for a user account and content items corresponding to the user account). Furthermore, the client application 112 can also display metadata and/or search query builder tools in a content search platform (in accordance with one or more implementations herein).

In some cases, the client device 110 can include a third party developer device that introduces the feature extraction component to the content management system 104 (e.g., as an implementation on a particular user account and/or as a plug in within a digital library accessible by multiple users). For instance, the content management system 104 can enable a third-party developer (corresponding to the third-party developer device) to prototype a feature extraction component in accordance with one or more implementations herein. In addition, the content management system 104 can enable a third-party developer device to upload or include the feature extraction component within a digital library (e.g., as a plugin). Upon receiving a user selection of the feature extraction component from the digital library by another user, the content management system 104 (via the search platform prototyping system 106) can integrate the feature extraction component within a search platform (or user content items) of the particular user (in accordance with one or more implementations herein).

As also shown in FIG. 1, the system 100 includes the administrator device 114. In one or more instances, the administrator device 114 include, but are not limited to, mobile devices (e.g., smartphones, tablets), laptops, desktops, or other types of computing devices, as explained below with reference to FIG. 9. For example, the administrator device 114 can be operated by users to perform various functions (e.g., via the administrator application 116 as a content management system application) such as, but not limited to, managing digital content, managing user accounts, implementing one or more features of the content management system 104, configuring the content management system 104, configuring and/or debugging a content search platform, and/or configuring user account or application settings of the content management system 104. Although FIG. 1 illustrates a single administrator device 114, in one or more embodiments, the system 100 can include various numbers and types of administrator devices.

In some cases, the administrator device 114, via the administrator application 116, can host one or more developer tools to test and/or debug a content search platform of the content management system 104. In particular, the administrator device 114 can display various developer graphical user interfaces to enable prototyping of feature extraction components (in accordance with one or more implementations herein) on live content of the content management system 104 (without affecting user experiences with the content management system 104). In addition, the administrator device 114 can also display various metadata and/or search query builder tools within the developer interfaces in accordance with one or more implementations herein.

As an example, an administrator (or developer) via the administrator device 114 can select and/or provide a feature extraction component. Moreover, the search platform prototyping system 106 can integrate the feature extraction component on the content search platform by modifying (or backfilling) metadata of content items of the content search platform. Then, the search platform prototyping system 106 can enable search queries and search results that utilize the modified metadata (based on the integrated feature extraction component) through the developer interface of the administrator device 114. Indeed, in one or more instances, even though live content items can be utilized, the search platform prototyping system 106 provides access to search results based on the integrated feature extraction component exclusively in the developer interface of the administrator device 114 (e.g., without affecting live content items and search results in client-side user interfaces).

Although one or more implementations illustrate the search platform prototyping system 106 integrating feature extraction components and/or displaying metadata as prototyping and/or developer tools, the search platform prototyping system 106 can utilize integrate feature extraction components (in accordance with one or more implementations herein) and/or display metadata (in accordance with one or more implementations herein) on live implementations of the content management system 104 (e.g., on individual user accounts and/or multiple user accounts).

Although FIG. 1 illustrates the search platform prototyping system 106 being implemented by a particular component and/or device within the system 100 (e.g., the server device(s) 102), in some embodiments, the search platform prototyping system 106 is implemented, in whole or part, by other computing devices and/or components in the system 100. For example, in some implementations, the search platform prototyping system 106 is implemented on the client device 110 within the client application 112 and/or the administrator device 114 within the administrator application 116. More specifically, in some embodiments, some or all of the search platform prototyping system 106 is implemented by the server device(s) 102 and accessed by the client device 110 and/or the administrator device 114 through the device applications, web browsers, and/or other online platforms (as described above). In some instances, some or all of the search platform prototyping system 106 is implemented by the client device 110 and/or the administrator device 114 and communicates data (or changes to data) to the content management system 104 on the server device(s) 102.

Additionally, as illustrated in FIG. 1, the system 100 includes the network 108 that enables communication between components of the system 100. In certain implementations, the network 108 includes a suitable network and may communicate using any communication platforms and technologies suitable for transporting data and/or communication signals between the server device(s) 102, the client device 110, and/or the administrator device 114. An example of the network 108 is described with reference to FIG. 9 and/or FIG. 10. Furthermore, although FIG. 1 illustrates the server device(s) 102, the client device 110, and the administrator device 114 communicating via the network 108, in certain implementations, the various components of the system 100 communicate and/or interact via other methods (e.g., the server device(s) 102 and the administrator device 114 communicating directly).

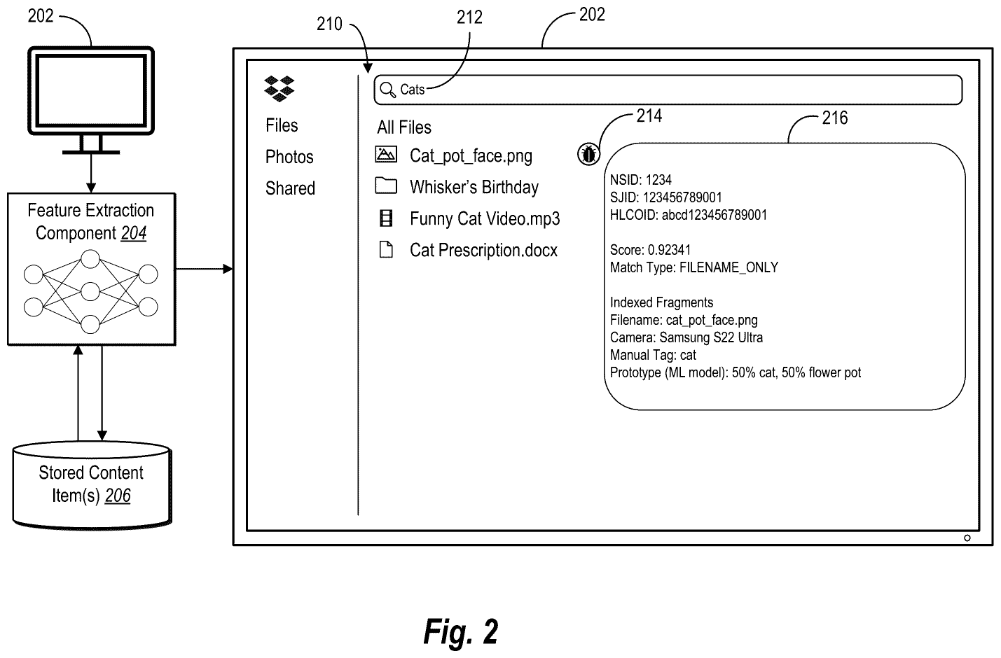

As mentioned above, the search platform prototyping system 106 can integrate functionalities within a content item search platform and also display extensive metadata associated with search results within the content item search platform. For instance, FIG. 2 illustrates an exemplary workflow of the search platform prototyping system 106. Indeed, FIG. 2 illustrates the search platform prototyping system 106 integrating a feature extraction component into a content item search platform and displaying search results based on the integrated feature extraction component.

As shown in FIG. 2, the search platform prototyping system 106 identifies a feature extraction component 204 from a client device 202. For example, in some cases, the search platform prototyping system 106 can identify the feature extraction component 204 based on receiving a user selection of a feature extraction component from a library and/or file repository that includes one or more feature extraction components (e.g., executable files for a feature extraction component). In some implementations, the search platform prototyping system 106 can identify the feature extraction component 204 based on receiving a user uploaded feature extraction component within a developer environment (e.g., or within a data pipeline) of the content item search platform. Moreover, in some instances, the search platform prototyping system 106 can identify the feature extraction component 204 from user provided code within a developer environment for programming and/or building feature extraction components. In some cases, the search platform prototyping system 106 can utilize code generation approaches to generate (or build) a feature extraction component.

Moreover, as shown in FIG. 2, the search platform prototyping system 106 utilizes the feature extraction component 204 with stored content item(s) 206 (on the content management system 104) to generate classifications (or classification labels) for the stored content item(s) 206. For example, the search platform prototyping system 106 utilizes the feature extraction component 204 to generate classification labels for content items (e.g., “cat,” “flower pot”) and corresponding classification label probabilities (e.g., “50%,” “40%,” “30%”). Indeed, the search platform prototyping system 106 assigns the generated classification labels to the stored content item(s) 206 (e.g., by including the labels and the label probabilities within metadata associated with the content items).

Additionally, as shown in FIG. 2, the search platform prototyping system 106 provides, for display within a graphical user interface 210 of the client device 202, a content item search platform that prototypes the feature extraction component 204. Indeed, as shown in FIG. 2, upon receiving a search query prompt 212 (e.g., “cats”) in the search platform of the graphical user interface 210, the search platform prototyping system 106 performs a search of the stored content item(s) 206 using the assigned classification labels from the feature extraction component 204. For instance, as illustrated in FIG. 2, the search platform prototyping system 106 utilizes the search query prompt 212 to identify stored content item(s) 206 that include classification labels (within metadata) generated by the feature extraction component 204 that match the search query prompt 212. Indeed, as shown in FIG. 2, the search platform prototyping system 106 displays various search results of content items (e.g., “cat_pot_face.png,” “whisker's Birthday,” “Funny Cat Video.mp3,” “cat prescription.docx”) based on the content item files having metadata that includes classification labels related to the term “cat.”

As also shown in FIG. 2, the search platform prototyping system 106 also displays, within the graphical user interface 210, a selectable metadata display option 214 that corresponds to (e.g., by being visually aligned with) a particular search result content item (e.g., “cat_pot_face.png”). Indeed, upon receiving a user interaction with the selectable metadata display option 214, the search platform prototyping system 106 displays metadata 216 for the particular search result content item (e.g., “cat_pot_face.png”). As illustrated in FIG. 2, the metadata 216 includes various information for the particular search result content item (e.g., identifiers, query match score to indicate a confidence of the search query match, search type, file name, camera type, tags). Although one or more embodiments illustrate a particular selectable option to display metadata, the search platform prototyping system 106 can display various user interface elements to request metadata, such as, but not limited to a right click option, a toolbar option, and/or a hover option.

In addition, as shown in FIG. 2, the metadata 216 also includes feature extraction component objects (e.g., indexed fragments) that indicate outputs of one or more feature extraction components. For instance, as shown in FIG. 2, the metadata 216 includes a feature extraction component object that indicates classification labels associated with the particular search result content item from a prototype machine learning model (e.g., the feature extraction component 204). Indeed, as shown in FIG. 2, the feature extraction component object of the metadata 216 indicates that the particular search result content item includes a classification label “cat” with a classification label probability of 50% and a classification label “flower pot” with a classification label probability of 50% (to indicate what the feature extraction component 204 determined is being portrayed in the particular search result content item). In particular, the search platform prototyping system 106 surfaces the particular search result content item based on the classification labels in the metadata 216 matching the search query prompt 212.

Although FIG. 2 (and one or more embodiments herein) illustrate a specific search query prompt (e.g., “cats”) and particular classification labels (e.g., “cat,” “person,” “medicine”), the search platform prototyping system 106 can generate various types of classification labels using various types of feature extraction components (as described above) to surface various content items in response to a variety of search query prompts. For example, the search platform prototyping system 106 can generate classification labels that indicate various car model depictions, airplane model depictions, food depictions, painting styles, photography styles, hairstyles, persons and can surface specific content items in response to search query prompts related to the various classification labels in accordance with one or more implementations herein.

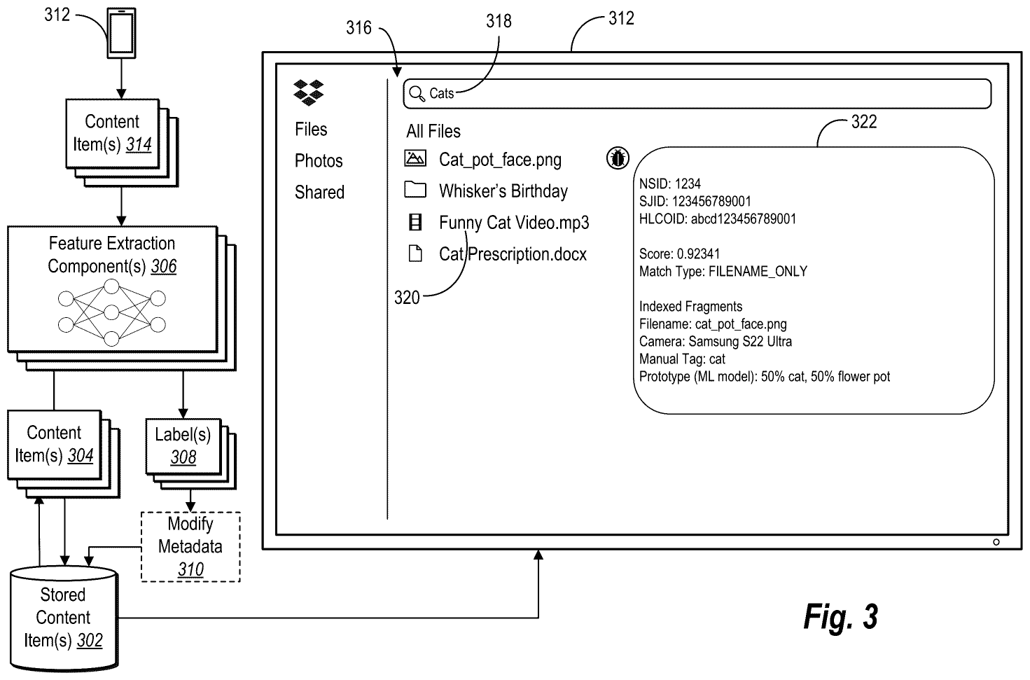

As mentioned above, the search platform prototyping system 106 can integrate various feature extraction components into a content item search platform corresponding to a set of content items. For instance, FIG. 3 illustrates the search platform prototyping system 106 deploying and integrating one or more feature extraction components with a content item search platform. In particular, FIG. 3 illustrates the search platform prototyping system 106 backfilling various classification labels from feature extraction components in metadata of content items to prototype search functionalities on the updated metadata.

For instance, as shown in FIG. 3, the search platform prototyping system 106 identifies a feature extraction component(s) 306 (as described above). Moreover, as illustrated in FIG. 3, the search platform prototyping system 106 utilizes the feature extraction component(s) 306 with a content item(s) 304 from stored content item(s) 302 to generate classification labels for the content item(s) 304. For instance, as shown in FIG. 3, the search platform prototyping system 106 utilizes the feature extraction component(s) 306 with the content item(s) 304 to generate a label(s) 308. As an example, in an act 310, the search platform prototyping system 106 can utilize the generated label(s) 308 to modify metadata corresponding to the content item(s) 304 within the stored content item(s) 302. By doing so, the search platform prototyping system 106 can update labels available for the content items in a live content item storage (to enable searching and testing for content items using the updated labels on real time data).

In one or more embodiments, the search platform prototyping system 106 can utilize various feature extraction components (e.g., the feature extraction component(s) 306) to generate various labels for content items (e.g., the label(s) 308). As an example, the search platform prototyping system 106 can utilize an image classification model (as the feature extraction component) to analyze digital images (e.g., content items) to identify and label various subjects depicted in the digital images (e.g., persons, animals, objects, buildings, plants). Indeed, the search platform prototyping system 106 can receive and/or identify multiple feature extraction components that classify or label different subjects in digital images. To illustrate, the search platform prototyping system 106 can identify a feature extraction component (e.g., an image classification model) trained to identify and label various types of animals depicted within digital images, a feature extraction component trained to identify and label various types of cars depicted within digital images, and/or a feature extraction component trained to identify and label various types of plants depicted within digital images.

In some cases, the search platform prototyping system 106 can utilize a text classification model (as the feature extraction component) to analyze text (e.g., text documents, spreadsheets, communications) to identify and label various subjects described in the text (e.g., persons, animals, objects, buildings, plants) and/or label the text in a particular category (e.g., fiction, non-fiction, food recipes, prescriptions, receipts, invoices, news article, review article, instruction manual). Furthermore, in some instances, the search platform prototyping system 106 can utilize a feature extraction component to analyze videos to identify and label various tags for the videos to indicate subjects and/or actions depicted within the videos. Indeed, the search platform prototyping system 106 can generate various types of labels for content items utilizing varying feature extraction components trained for particular tasks.

In some instances, to deploy the feature extraction component, the search platform prototyping system 106 utilizes an existing data pipeline having various data dispatchers, configurators, event streaming platforms (e.g., Kafka platforms, Apache platforms), and/or other database processors with the feature extraction component. For instance, the search platform prototyping system 106 can introduce the selected feature extraction component into the existing data pipeline of the content management system to integrate the feature extraction component on content items within the content management system. In particular, the search platform prototyping system 106 can configure the data pipeline to execute on a feature extractor that includes data management services to process data at a frontend and postprocess data using various components of the existing data pipeline (e.g., the data dispatchers, configurators, event streaming platforms, other database processors). The search platform prototyping system 106 can introduce the selected (new) feature extraction component within the data pipeline while maintaining the existing frontend, and postprocess data components of the feature extractor in the pipeline to utilize the newly added feature extraction component.

Moreover, in one or more instances, the search platform prototyping system 106 can assign the generated labels to content items in the stored content items (e.g., the stored content item(s) 302). For example, the search platform prototyping system 106 can backfill (and/or index) generated labels into existing content items by associating the generated labels to the content items. In some instances, the search platform prototyping system 106 maps the generated labels to the content items. In one or more instances, the search platform prototyping system 106 modifies metadata associated with the content items to include the generated labels within content items.

For example, the search platform prototyping system 106 can modify metadata associated with the content items to include one or more feature extraction component objects (e.g., fragments) within the metadata (and/or a mapping) of the content item. Indeed, the feature extraction component objects can include data, such as, but not limited to, the type of feature extraction component utilized for the added feature extraction component object (e.g., a specific image classification model, a specific text classification model), one or more classification labels generated by the feature extraction component, and/or classification label probabilities associated with the generated labels. Indeed, the search platform prototyping system 106 can modify metadata to include multiple feature extraction component objects (for multiple feature extraction components utilized on the content items).

Furthermore, in some cases, the search platform prototyping system 106 can utilize a deployed feature extraction component to generate labels for additional (new) content items received within the content management system. For example, as shown in FIG. 3, the search platform prototyping system 106 can receive a content item(s) 314 from the client device 312 (e.g., an uploaded content item, created content on the content management system). Moreover, as shown in FIG. 3, the search platform prototyping system 106 utilizes the content item(s) 314 with the feature extraction component(s) 306 to generate the label(s) 308 for the content item(s) 314. Furthermore, as shown in FIG. 3, the search platform prototyping system 106 can store the content item(s) 314 with assigned labels (e.g., via metadata modification) in the stored content item(s) 302.

In some cases, the search platform prototyping system 106 can utilize a deployed feature extraction component to generate labels for content items of a particular namespace. For instance, the search platform prototyping system 106 can identify a namespace associated with a developer account and/or a namespace selected by a user and generate labels (with the feature extraction component) for one or more content items associated with the namespace. Indeed, in some cases, the search platform prototyping system 106 utilizes a particular prototyping namespace that includes various test (or prototyping) content items to prototype various feature extraction components in accordance with one or more implementations.

In addition, the search platform prototyping system 106 can utilize the content items with the added labels (e.g., via backfilling from the integrated feature extraction component) within a content search platform. Indeed, as shown in FIG. 3, the search platform prototyping system 106 provides, for display within a graphical user interface 316 of a client device 312, a content item search platform. As shown in FIG. 3, upon receiving a search query prompt 318, the search platform prototyping system 106 can utilize the search query prompt 318 with the stored content item(s) 302 (with the modified metadata) to identify content items relevant for the search query prompt 318. For instance, as illustrated in FIG. 3, the search platform prototyping system 106 identifies various content items 320 (e.g., images, folders, videos, documents) that include classification labels corresponding to the search query prompt 318 (e.g., content items with labels relevant or matching to “cats”).

In some instances, the search platform prototyping system 106 determines similarities between the search query prompt to classification labels within the content items to identify the content items as search results. For example, the search platform prototyping system 106 can identify one or more classification labels that correspond to the search query prompt (e.g., via matching text, via a similarity score, via k-means clustering, ranking). Moreover, the search platform prototyping system 106 can select one or more content items with the identified classification labels to surface as search results. In some cases, the search platform prototyping system 106 selects the one or more content items utilizing the classification label probabilities corresponding to the content items.

As an example, the search platform prototyping system 106 can utilize a threshold confidence score to select the content items as search results. For instance, the search platform prototyping system 106 can compare the classification label probabilities to a threshold confidence score to determine whether a content item includes a classification label that is relevant for the search query prompt. Indeed, the search platform prototyping system 106 can select a content item when the content item has a matching classification label with a classification label probability that satisfies (or meets) the threshold confidence score (e.g., is equal to and/or greater than the threshold confidence score).

In some cases, the search platform prototyping system 106 can utilize ranking to select content items as search results. For example, the search platform prototyping system 106 can utilize classification label probabilities for classification labels relevant to a search query prompt of content items to rank the content items. Then, the search platform prototyping system 106 can display the content items as search results utilizing the rankings (e.g., highest score to lowest score, lowest score to highest score).

To illustrate, the search platform prototyping system 106 can identify a content item with a classification label of “cat” (with a classification label probability of 0.8) for a search query prompt “cats.” The search platform prototyping system 106 can compare the classification label probability (of 0.8) to a threshold confidence score (e.g., 0.7). As a result of the classification label probability (of 0.8) satisfying the threshold confidence score (e.g., 0.7), the search platform prototyping system 106 can select the content item for the search query prompt. To further illustrate, the search platform prototyping system 106 can identify an additional content item with a classification label of “cat” (with a classification label probability of 0.4) for the search query prompt “cats.” As a result of the classification label probability (of 0.4) not satisfying the threshold confidence score (e.g., 0.7), the search platform prototyping system 106 can forgo selection of the content item for the search query prompt.

Although one or more embodiments describe a particular threshold confidence score, the search platform prototyping system 106 can utilize a variety of threshold confidence scores configured by an administrator via an administrator device, determined via statistical computation, and/or determined via a machine learning model.

As further shown in FIG. 3, the search platform prototyping system 106 displays metadata for a search result. For instance, as shown in FIG. 3, the search platform prototyping system 106 can display metadata 322 for a content item search result within the graphical user interface 316 (of the content item search platform). Indeed, in one or more cases, the search platform prototyping system 106 can display the metadata 322 to indicate various information for the content item and one or more classification labels associated with the content item (from one or more deployed and/or integrated feature extraction components).

In some cases, the search platform prototyping system 106 can identify one or more identifiers associated with the content item to display the identifiers within the metadata. For instance, the search platform prototyping system 106 can identify various identifiers associated with the content item that result from references to the content item in multiple sources corresponding to the content item. For instance, the search platform prototyping system 106 can identify an identifier for the content item provided by a database management system. Moreover, the search platform prototyping system 106 can identify an addition identifier for the content item provided by an encryption application. Indeed, the search platform prototyping system 106 can collect (or gather) identifiers associated with the content item from multiple sources and include the identifiers within the metadata.

By doing so, the search platform prototyping system 106 can display metadata for the content item that indicate identifiers that are often only accessible via the different applications or systems. This enables access to multiple identifiers for the content item in the search results in a single interface (e.g., to improve ease of access for debugging a search query and/or determining why a content item is surfacing or not surfacing in response to a search query). In addition, the consolidated metadata having the multiple identifiers enables users (i.e., developers) to pinpoint the content item in the various independent systems and/or applications that have different identifiers for the content item.

Furthermore, the search platform prototyping system 106 can display metadata that includes outputs of one or more feature extraction components (in accordance with one or more implementations herein). For instance, the search platform prototyping system 106 can display data objects (e.g., fragments) that indicate a particular feature extraction component and outputs of the particular feature extraction component for a content item. Indeed, as shown in FIG. 3, the search platform prototyping system 106 can display data objects within the metadata 322 that indicate a particular feature extraction component, classification labels output by the feature extraction component, and classification label probabilities for the classification labels (for a content item). In one or more instances, the search platform prototyping system 106 can display multiple data objects to represent multiple feature extraction components and outputs of the multiple feature extraction components.

In one or more implementations, the search platform prototyping system 106 displays the metadata with the outputs of the feature extraction components to enable (or facilitate) debugging of the integration of the feature extraction component within the content item search platform. For instance, the search platform prototyping system 106 can display the metadata with the classification labels of the feature extraction component to enable a developer to view operability of a feature extraction component in response to search query prompts on the content item search platform.

For instance, the search platform prototyping system 106 can display the content items as search results and the metadata with the feature extraction component outputs in a developer, prototyping environment that is viewable via a developer interface (or an administrator interface). Indeed, in some cases, the search platform prototyping system 106 adds the feature extraction component output data to the metadata and utilizes the feature extraction component output data with a search query prompt within the developer interface (e.g., on live content item data). Moreover, in one or more implementations, the search platform prototyping system 106 excludes the feature extraction component output data in a search query prompt provided by a user in a non-developer interface (e.g., on live content item data) to utilize existing approaches for the content item search. However, the search platform prototyping system 106 can implement feature extraction components in accordance with one or more implementations on live content data for use in a developer platform and/or in a frontend user interface for the search platform.

In some cases, the search platform prototyping system 106 migrates data created by a prototyped feature extraction component to a live search platform. For instance, the search platform prototyping system 106 can enable searching of content items based on labels and/or other data generated by a feature extraction component for content item(s) for users on a live version of a content item search platform of a content management system. In addition, the search platform prototyping system 106 can migrate logic and/or other configuration data of a feature extraction component to operate on live data of the content management system across multiple user accounts to enable the feature extraction component to determine labels for content items introduced in the content management system (and/or existing content items on the content management system). Moreover, the search platform prototyping system 106 can utilize the generated labels and/or other data to enable searching content items based on the generated labels and/or other data by active users on the content management system (in accordance with one or more implementations herein).

Furthermore, as shown in FIG. 3, the search platform prototyping system 106 can enable implementing and/or adding multiple feature extraction component(s) to one or more content items in the stored content item(s) 302. Indeed, the search platform prototyping system 106 can determine and assign various numbers of labels from various numbers of feature extraction components for the content items in the stored content item(s) 302.

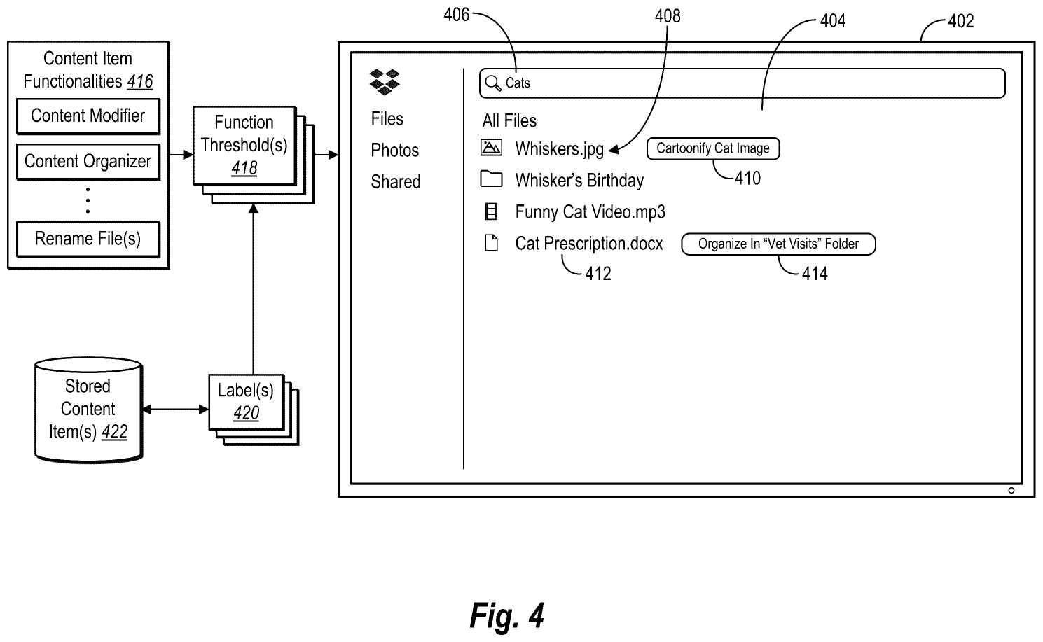

In addition, the search platform prototyping system 106 can provide, for display within a graphical user interface of a search platform, a content item modification function for one or more content items based on labels from a feature extraction component. For instance, FIG. 4 illustrates the search platform prototyping system 106 displaying a content item modification function based on labels from a feature extraction component. In particular, FIG. 4 illustrates the search platform prototyping system 106 identifying content item modification functions that are relevant to (or correspond to) one or more labels assigned to content items that are surfaced in response to a search query prompt (in accordance with one or more implementations herein).

For instance, as shown in FIG. 4, the search platform prototyping system 106 can provide, for display within a graphical user interface 404 of a client device 402, a content item search platform. As further shown in FIG. 4, the search platform prototyping system 106, via the graphical user interface 404, receives a search query prompt 406 (e.g., “cats”). Furthermore, in response to the search query prompt 406, the search platform prototyping system 106 provides for display (surfaces), in the graphical user interface 404, content items based on feature extraction component labels (in accordance with one or more implementations herein).

In addition, as shown in FIG. 4, the search platform prototyping system 106 identifies a collection of content item functionalities 416 (e.g., content modifier, content organizer, rename file(s)). Moreover, as shown in FIG. 4, the search platform prototyping system 106 utilizes label(s) 420 from a store content item(s) 422 (of content items being surfaced in response to the search query prompt 406) to identify one or more content item functionalities for the content items (from the collection of content item functionalities 416). Indeed, as shown in FIG. 4, the search platform prototyping system 106 utilizes a function threshold(s) 418 with the label(s) 420 to map a content item functionality from the collection of content item functionalities 416 to content items surfaced in response to the search query prompt 406.

In some cases, the function threshold(s) 418 can include a threshold confidence score (or class label probability) value assigned to content item functionality from the collection of content item functionalities 416. For instance, a content item functionality can include an implementation of a function to perform on a content item (e.g., content modification, content organization, file modification), one or more trigger labels for the content item functionality, and the function threshold (e.g., a threshold class label probability value). For example, the content item functionality can include one or more trigger labels that cause the search platform prototyping system 106 to enable (and/or present) the content item functionality in relation to a content item that includes a matching (or similar) trigger label. Then, the search platform prototyping system 106 determines if the matching (or similar) label from the content item includes a class label probability (or score) that meets (or satisfies) the function threshold (e.g., a threshold class label probability value). Upon meeting the function threshold (e.g., the content item class label assigned probability is greater than and/or equal to the function threshold), the search platform prototyping system 106 can enable (or display) the content item functionality in relation to the content item.

For instance, in reference to FIG. 4, the search platform prototyping system 106 can identify a class label probability for the content item 408. Upon comparing the class label probability for the content item 408 to the function threshold(s) 418 for a particular content item functionality from the collection of content item functionalities 416, the search platform prototyping system 106 can determine that a content item function 410 corresponds to (or is relevant to) the content item 408. In particular, the search platform prototyping system 106 can identify that the content item 408 corresponds to a class label of “cat” and the content item function 410 (e.g., cartoonify cat images) also correspond to a class label of “cat” (with a satisfied threshold class probability). In response, the search platform prototyping system 106 displays the content item function 410 (e.g., cartoonify cat images) for the content item 408. In some implementations, based on receiving a user interaction with the content item function 410, the search platform prototyping system 106 can modify the content item 408 based on the content item function 410 (e.g., by changing the image content item to be in a cartoon style).

As also shown in FIG. 4, the search platform prototyping system 106 can identify a class label probability for the content item 412. Based on comparing the class label probability for the content item 412 to the function threshold(s) 418 for a particular content item functionality from the collection of content item functionalities 416, the search platform prototyping system 106 can determine that a content item function 414 corresponds to (or is relevant to) the content item 412. Indeed, the search platform prototyping system 106 can identify that the content item 412 corresponds to a class label of “cat medical” and the content item function 410 (e.g., organize in “Vet Visits” folder) also correspond to a class label of “cat medical” (with a satisfied threshold class probability). In response, the search platform prototyping system 106 displays the content item function 414 (e.g., organize in “Vet Visits” folder) for the content item 412. In some implementations, based on receiving a user interaction with the content item function 414, the search platform prototyping system 106 can move the content item 412 to the folder “Vet Visits” (which can also be assigned to the class label “cat medical”).

In one or more embodiments, the search platform prototyping system 106 can identify and/or surface various content item functions for content item search results based on feature extraction component labels (generated and assigned in accordance with one or more implementations herein). For example, the search platform prototyping system 106 can surface content item functions, such as, but not limited to, content modifiers (e.g., changing image styles, changing photo attributes, such as brightness, exposure, saturation, changing font styles, changing audio levels), content organizers (e.g., moving content item files, combining content items, splitting content item files), and/or content item file modifiers (e.g., renaming content item files, changing metadata associated with the content item files).

Although one or more instances above illustrate the search platform prototyping system 106 displaying content item functions (for utilization) for content items within search results, the search platform prototyping system 106 can also perform various tasks with the identified content item functions. For instance, in some implementations, the search platform prototyping system 106 can identify an association between a content item function and a content item (in accordance with one or more implementations described herein) (e.g., as a background task and/or in a search result) and automatically provide the content item to a system or application that implements the content item function. For instance, the search platform prototyping system 106 can automatically provide a content item to an image quality enhancement application based on identifying particular EXIF data within feature extraction data.

In some cases, the search platform prototyping system 106 can provide transparency into one or more feature extraction components (e.g., machine learning models) operating on content items for a content item search platform. For instance, the search platform prototyping system 106 can identify (via metadata as described herein) outputs of one or more feature extraction components that are applied to content items on the content item search platform. Then, the search platform prototyping system 106 can display the outputs of the one or more feature extraction components to provide transparency (of machine learning models) in content item search results.

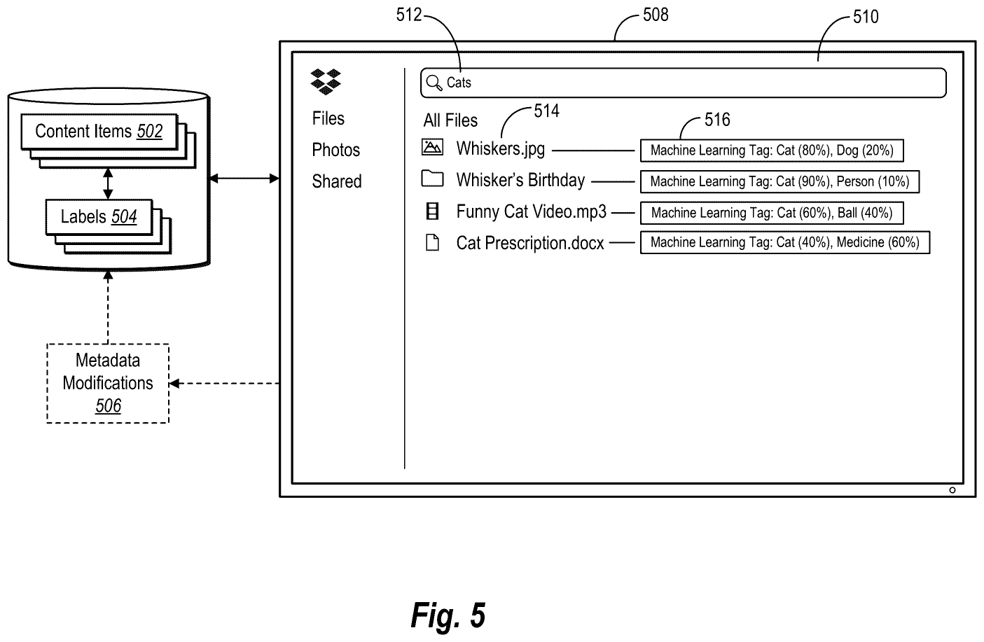

For instance, FIG. 5 illustrates the search platform prototyping system 106 displaying output data of one or more feature extraction components as part of content item search results. As shown in FIG. 5, the search platform prototyping system 106 provides for display, within a graphical user interface 510 of a client device 508, a content item search platform. Furthermore, as shown in FIG. 5, the search platform prototyping system 106 receives a search query prompt 512 (in the graphical user interface 510) and identifies content items 514 from the content items 502 with corresponding labels 504 (determined in accordance with one or more implementations herein).

In addition, the search platform prototyping system 106 utilizes the labels 504 (and corresponding class label probabilities) to display outputs of the feature extraction components. Indeed, as shown in FIG. 5, the search platform prototyping system 106 displays outputs 516 to indicate machine learning tags generated for the search result content items 514. As shown in FIG. 5, the outputs 516 indicate class labels and class label probabilities generated for content items.

In some cases, the search platform prototyping system 106 displays outputs for a content item from multiple feature extraction components (e.g., machine learning models) applied on the content item. In addition, in some implementations, the search platform prototyping system 106 can also display various information for the one or more machine learning models applied on the content item. In particular, the search platform prototyping system 106 can display information for a machine learning model, such as, but not limited to version history of the machine learning model, machine learning model names, machine learning model type, and/or machine learning model training information.

Although FIG. 5 illustrates the search platform prototyping system 106 displaying machine learning tags as outputs of a feature extraction component, the search platform prototyping system 106 can display various outputs of various types of feature extraction components within the graphical user interface of the search platform. For instance, the search platform prototyping system 106 can display vector outputs from feature extraction components. Moreover, the search platform prototyping system 106 can display feature extraction data generated for content items (by one or more feature extraction components), such as, but not limited to, EXIF data, text descriptions or summarizations generated for content items, and/or image properties (e.g., resolution, color space) as output data within the graphical user interface of the search platform.

In some instances, the search platform prototyping system 106 can facilitate feedback and/or modification of the feature extraction component outputs (e.g., the labels and/or label probabilities). For instance, as shown in FIG. 5, the search platform prototyping system 106 can receive metadata modifications (in an act 506) for data from the outputs 516 of content items 514 displayed within the graphical user interface 510. Indeed, the search platform prototyping system 106 can utilize one or more modifications received in the act 506 to modify a label corresponding to a content item, metadata corresponding to the content item, and/or modify parameters of a feature extraction component (e.g., training parameters).

For example, in some cases the search platform prototyping system 106 can utilize feedback and/or modifications to the output data (e.g., labels and/or label probabilities) to modify (or learn) parameters of a feature extraction component. For example, the search platform prototyping system 106 can receive feedback from a search platform user interface (e.g., via user interactions) indicating whether a label is correct and/or incorrect. In response, the search platform prototyping system 106 can utilize the feedback to learn parameters of the feature extraction component (e.g., reinforce parameters when feedback indicates a correct label and/or change parameters when the feedback indicates an incorrect label). For instance, the search platform prototyping system 106 can utilize the feedback to generate a loss value and utilize the loss value to modify (or learn) parameters of the feature extraction component.

In some cases, the search platform prototyping system 106 modifies class label probabilities (or scores) associated with a label on a content item based on feedback and/or modifications to output data of content items in a search result. For instance, the search platform prototyping system 106 can increase a class label probability associated with a label when feedback indicating a correct label is received via the graphical user interface. In some instances, the search platform prototyping system 106 can decrease the class label probability associated with a label when feedback indicating an incorrect label is received via the graphical user interface.

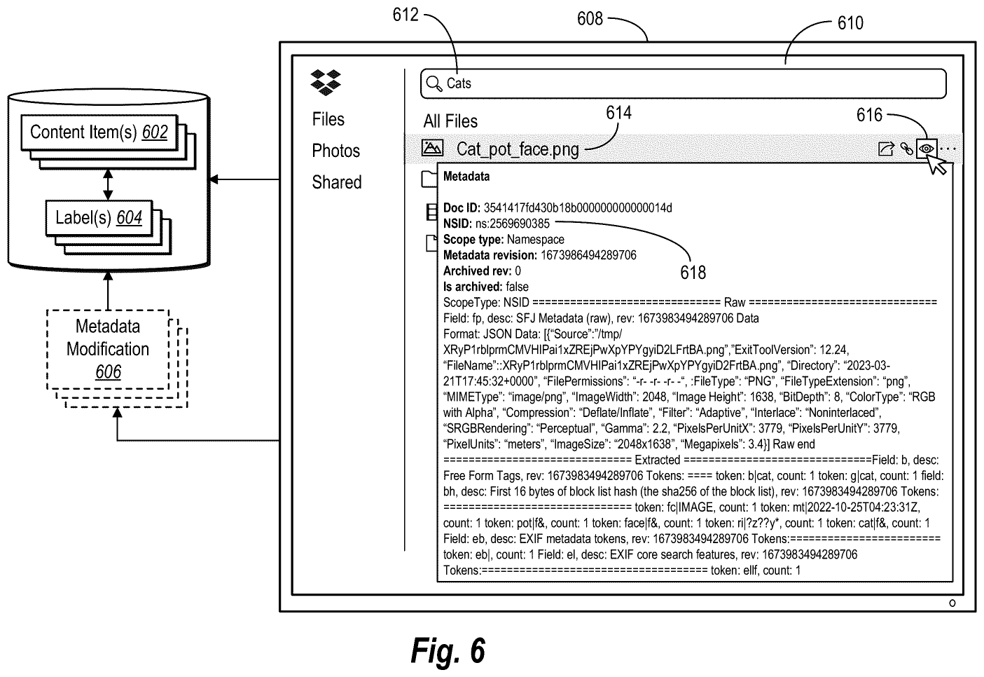

In one or more implementations, the search platform prototyping system 106 can display (raw) metadata of a content item as part of a search result in a content item search platform. In particular, the search platform prototyping system 106 can display metadata for a content item consolidated from one or more sources to provide a holistic insight into information of a content item in a single interface in relation to a content item as a search result. For example, FIG. 6 illustrates the search platform prototyping system 106 displaying consolidated metadata for a content item search result within a search platform.

As shown in FIG. 6, the search platform prototyping system 106 can receive a search query prompt 612 within a graphical user interface 610 of a content item search platform (in a client device 608). In response to the search query prompt 612, the search platform prototyping system 106 identifies content items based on feature extraction component labels (in accordance with one or more implementations herein) from content item(s) 602 with label(s) 604. In addition, the search platform prototyping system 106 can display identified content items in the graphical user interface 610 of a content item search platform. For instance, as shown in FIG. 6, the search platform prototyping system 106 displays a content item 614 in response to the search query prompt 612 (in accordance with one or more implementations herein).

As further shown in FIG. 6, the search platform prototyping system 106 can display, in relation to the content item 614, a selectable option 616 to view metadata associated with the content item 614. Indeed, as shown in FIG. 6, based on a user interaction with the selectable option 616, the search platform prototyping system 106 displays an overlay user interface for metadata 618. As illustrated in FIG. 6, the search platform prototyping system 106 can display the overlay user interface for the metadata 618 to present a consolidation of metadata available for the content item 614 from one or more sources in a single user interface (without user navigation away from the content item search platform). Furthermore, the metadata 618 can be displayed within a JSON format and/or various other formats, such as, but not limited to, plain text, spreadsheets, matrix objects, and/or XML objects.

For instance, as shown in FIG. 6, the metadata 618 can include multiple identifiers for the content item 614. In some cases, the metadata can include, but is not limited to, a file identifier for a content item within the content management filing system, a database identifier, a version identifier, and/or a user account specific identifier. For example, the search platform prototyping system 106 can generate metadata that includes, but is not limited to, namespace identifiers (NSIDs), SJID identifiers, and/or HLCOID identifiers. In addition, the metadata can also include a revision identifier that indicates a versioning (and/or an update history) of the metadata associated with the content item from one or more modifications (in accordance with one or more implementations herein). In addition, as shown in FIG. 6, the metadata 618 can include various other information. For instance, the metadata 618 can include, but is not limited to, archive flags, file permissions data, file type data, image parameters, and/or file size. In some cases, the search platform prototyping system 106 can generate metadata that includes, but is not limited to, ranking scores, match type information, and/or information from debugging logs.

Furthermore, as shown in FIG. 6, the metadata 618 can include data assigned from a feature extraction component on the content item 614. For example, the search platform prototyping system 106 can utilize output data from a feature extraction component to assign (classification) labels (or tags) within the metadata 618 for the content item 614 (e.g., “extracted” section of the metadata 618). In response to the output data of the feature extraction component, the search platform prototyping system 106 generates the metadata 618 to include tags (or labels) extracted by the feature extraction component. Furthermore, the metadata 618 can include timestamps, tokens, and/or other fields for the label generated by the feature extraction component.

In one or more instances, the search platform prototyping system 106 displays the selectable option 616 and the metadata 618 within a developer user interface for a testing environment. Indeed, the search platform prototyping system 106 can display the metadata 618 in a developer device (or administrator device) to enable a developer (or administrator) user to view metadata in relation to a search query prompt within the content item search platform. In particular, the search platform prototyping system 106 enables a user to troubleshoot and/or debug the search features in the search platform via comparisons of the metadata to the search query prompt. In addition, the search platform prototyping system 106 can enable the user to utilize the various identifiers and/or other information in the metadata 618 to reference the content item 614 within one or more backend systems and/or third-party systems to resolve various debugging and/or troubleshooting issues with the content item in response to search query prompts (and/or the search platform).

Although FIG. 6 illustrates the metadata 618 with a single label from a feature extraction component, the search platform prototyping system 106 can include various labels from various feature extraction components in the metadata (in accordance with one or more embodiments herein). Furthermore, the search platform prototyping system 106 can include and display metadata for each content item surfaced within a content search platform (in accordance with one or more embodiments herein). In addition, although one or more embodiments illustrate the search platform prototyping system 106 displaying metadata as part of a content item search platform, the search platform prototyping system 106 can display metadata (in accordance with one or more implementations) in various interfaces, such as, but not limited to, in a file management interface of the content management system.

As further shown in FIG. 6, in some cases, the search platform prototyping system 106 can also enable (or facilitate) metadata modifications 606 to the metadata of a content item. For instance, the search platform prototyping system 106 can enable users to interact with the metadata 618 to edit the contents of the metadata. In one or more instances, the search platform prototyping system 106 can update metadata and/or labels for the content item(s) 602 (and/or the label(s) 604) based on the metadata modifications 606 identified in the graphical user interface 610. In some cases, the search platform prototyping system 106 can utilize the metadata modifications to modify parameters of one or more feature extraction components (in accordance with one or more implementations herein).

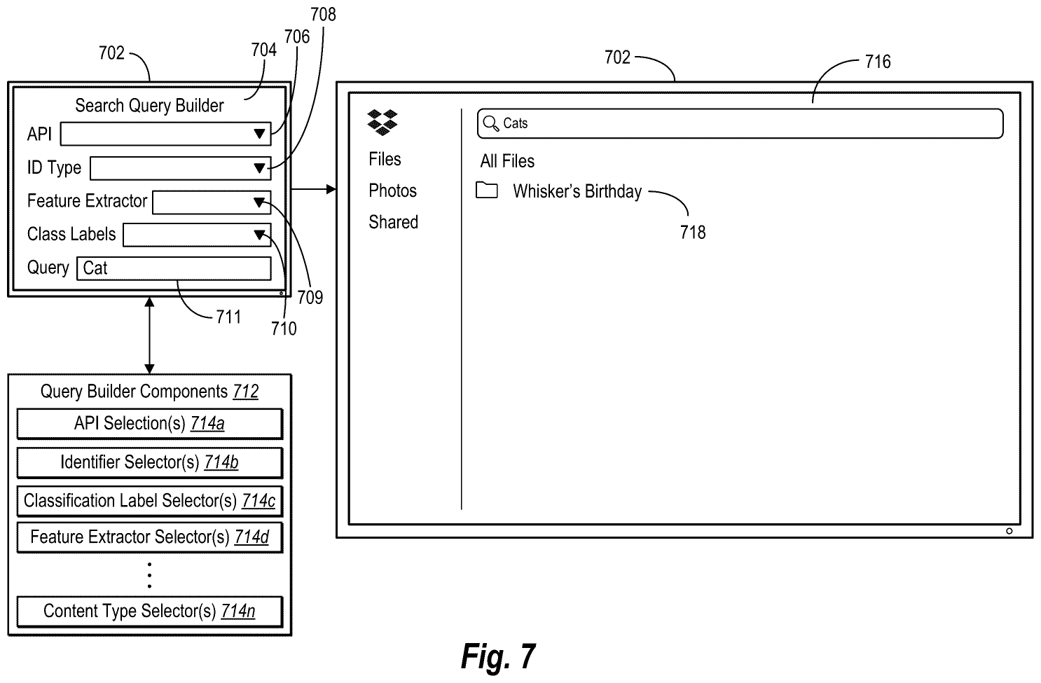

As mentioned above, the search platform prototyping system 106 can also enable one or more selectable user interface elements for search query building tools within the search platform of the content management system. For instance, FIG. 7 illustrates the search platform prototyping system 106 facilitating one or more search query builder options within a graphical user interface for a search query prompt.

As shown in FIG. 7, the search platform prototyping system 106 can provide, for display within a graphical user interface 704 of a client device 702, various search query building options (e.g., selectable interface elements 706, 708, 710, 711) for a search query from query builder components 712. Indeed, as shown in FIG. 7, the search platform prototyping system 106 displays a selectable interface element 706 to select an API (or API source) to focus search results to content items associated with a particular API from API selection(s) 714a. In addition, as illustrated in FIG. 7, the search platform prototyping system 106 displays a selectable interface element 708 to select an ID type to focus search results to content items associated with a particular ID type from identifier selector(s) 714b. Moreover, the search platform prototyping system 106 displays a selectable interface element 710 to select class labels to focus search results to content items associated with a particular class label from classification label selector(s) 714c. In some cases, the search platform prototyping system 106 can also include selectable options to select a content type from the content type selector(s) 714n.

Moreover, as shown in FIG. 7, the search platform prototyping system 106 can provide, for display within the graphical user interface 704 of the client device 702, a selectable interface element 709 to select a feature extractor component (from feature extractor selector(s) 714d). Indeed, the search platform prototyping system 106 can receive a feature extractor component selection to focus search results to content items that are associated with (or have been analyzed by) the selected feature extractor component (from the selectable interface element 709). Indeed, the search platform prototyping system 106 can filter search results to include content items that have feature extraction data assigned (or tagged) from a selected feature extractor component.

In some cases, the search platform prototyping system 106 can provide, within a graphical user interface, selectable interface elements to facilitate a multi-selection of one or more selectable components (e.g., the feature extractor components, classification label selections, identifier selections). For instance, the search platform prototyping system 106 can receive multiple selections of feature extraction components and focus search results to content items that are associated with (or have been analyzed by) the selected multiple feature extractor components. Moreover, the search platform prototyping system 106 can enable selection of multiple combinations of various selectable components (e.g., an identifier type selection and a feature extractor component selection). Furthermore, in some cases, the search platform prototyping system 106 can also enable negative selection to filter search results to include content items not associated with a selected component (e.g., search results of content items not exposed to feature extraction components).

Additionally, as shown in FIG. 7, the search platform prototyping system 106 utilizes a selectable interface element 711 for a search query prompt (in the search query builder) to provide, for display within a graphical user interface 716 of a client device 702, a search platform with search results based on the selected options in the graphical user interface 704 of the search query builder. Indeed, as shown in FIG. 7, the search platform prototyping system 106, based on receiving search query builder selections that request to focus on a file type of folders), displays, for the search query prompt (e.g., “cats”) from the selectable interface element 711, a folder 718 (as a search result) that is associated with the search query prompt based on one or more labels generated using feature extraction components (in accordance with one or more implementations herein). Indeed, the search platform prototyping system 106 can utilize the search query builder options to customize and/or specify particular search parameters for a search query prompt to surface content items (in accordance with one or more implementations herein).

In some cases, the search platform prototyping system 106 can enable users to select a particular feature extraction component as a search query builder option to focus search results on content items that have a particular feature extraction component applied. In some embodiments, the search platform prototyping system 106 can enable users to select a particular label type as a search query builder option to focus search results on content items that include a particular label type (e.g., a classification label, a formatting label, a rating label). In some cases, the search platform prototyping system 106 can enable users to select particular identifiers and/or APIs to focus search results on content items that are associated (or include) a particular type of identifier and/or can interface with a particular type of API.

Furthermore, in some cases, the search platform prototyping system 106 can enable users to select a particular root namespace as a search query builder option to focus search results on content items that belong to the particular root namespace. In particular, the search platform prototyping system 106 can receive a selection to utilize a namespace corresponding to the developer user and/or one or more other user accounts. Then, the search platform prototyping system 106 can retrieve content items in response to a search query prompt from the particular namespace utilizing one or more labels generated using one or more feature extraction components (in accordance with one or more implementations).

Additionally, although FIG. 7 illustrates one or more search query builder options within dropdown list interface elements, the search platform prototyping system 106 can display and/or enable one or more search query builder options via various selectable interface elements, such as, but not limited to, radio buttons, search bars, command line tools, click and drag elements (e.g., click and drag particular search query builder options into a search query prompt bar).

In one or more implementations, the search platform prototyping system 106 can utilize command-line interface tools and/or other interface tools to enable third-party developers and/or administrators to prototype and/or test various functionalities of the search platform (in accordance with one or more implementations). For instance, the search platform prototyping system 106 can enable a third-party developer and/or administrator to implement a prototype feature extraction component within a particular namespace accessible by the third-party developer and/or administrator in accordance with one or more implementations herein. In addition, the search platform prototyping system 106 can also enable the third-party developer and/or administrator to access metadata and/or search query builder options to prototype and/or view search results (in accordance with one or more implementations herein) within a search platform of the content management system.

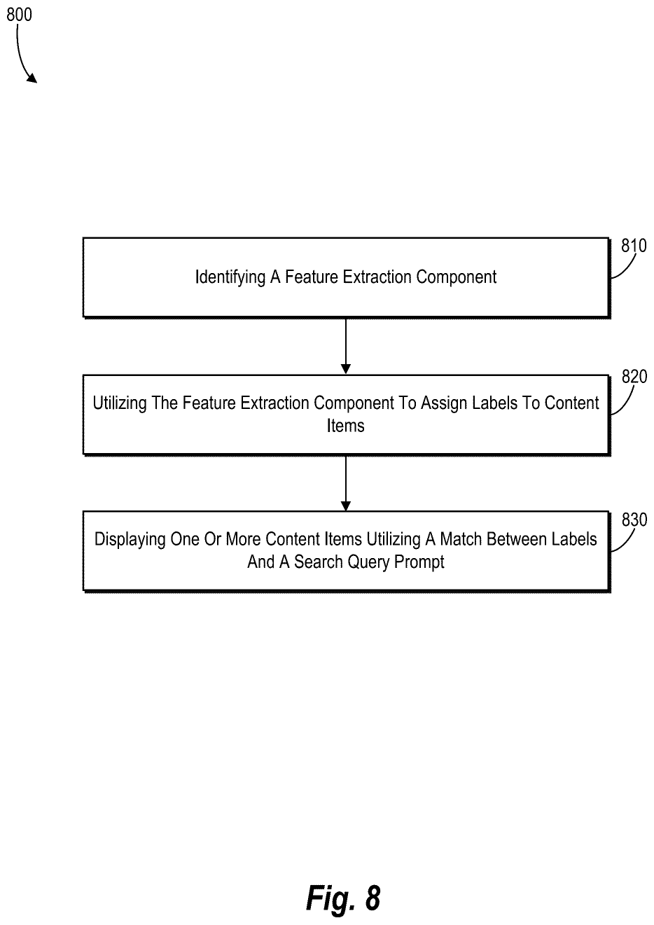

FIGS. 1-7, the corresponding text, and the examples provide a number of different methods, systems, devices, and non-transitory computer-readable media of the search platform prototyping system 106. In addition to the foregoing, one or more implementations can also be described in terms of flowcharts comprising acts for accomplishing a particular result, as shown in FIG. 8. The acts shown in FIG. 8 may be performed in connection with more or fewer acts. Furthermore, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 8. In some implementations, a system can be configured to perform the acts of FIG. 8. Alternatively, the acts of FIG. 8 can be performed as part of a computer-implemented method.

FIG. 8 illustrates a flowchart of a series of acts 800 for integrating feature extraction functionalities within a content item search platform in accordance with one or more implementations herein. While FIG. 8 illustrates acts according to one implementation, alternative implementations may omit, add to, reorder, and/or modify any of the acts shown in FIG. 8.

As shown in FIG. 8, the series of acts 800 include an act 810 of identifying a feature extraction component, an act 820 of utilizing the feature extraction component to assign labels to content items, and an act 830 of displaying one or more content items utilizing a match between labels and a search query prompt.

In some embodiments, the act 810 can include identifying a user selection of a feature extraction component to integrate within a searchable content management system comprising a set of content items, the act 820 can include, based on deployment of the feature extraction component, utilizing the feature extraction component with the set of content items to automatically assign one or more labels to the set of content items, and the act 830 can include, based on receiving a search query prompt within a content search platform of the searchable content management system, providing, for display within a graphical user interface, one or more content items from the set of content items utilizing a match between the one or more labels and the search query prompt.

In some cases, the act 810 can include identifying a feature extraction component that enables a classification model to output classification labels for a set of content items within a searchable content management system, the act 820 can include, based on deployment of the feature extraction component, utilizing the feature extraction component with the set of content items to automatically map one or more classification labels from the classification model to the set of content items, and the act 830 can include, based on receiving a search query prompt within a content search platform of the searchable content management system, provide for display, within a graphical user interface, one or more content items from the set of content items utilizing a match between the one or more classification labels and the search query prompt.

In some instances, the act 810 and the act 820 can include utilizing a feature extraction component deployed in a searchable content management system, the feature extraction component enabling a classification model to output classification labels for a set of content items within the searchable content management system to automatically map one or more classification labels from the classification model to the set of content items and the act 830 can include, based on receiving a search query prompt within a content search platform of the searchable content management system, providing for display, within a graphical user interface, one or more content items from the set of content items utilizing a match between the one or more classification labels and the search query prompt.

In one or more instances, the act 810 can include identifying a feature extraction component comprising a classification model to integrate within a searchable content management system comprising a set of content items, the act 820 can include utilizing the feature extraction component with the set of content items to automatically assign one or more classification labels to the set of content items, and the act 830 can include, based on receiving a search query prompt within a content search platform of the searchable content management system, provide for display, within a graphical user interface, one or more content items from the set of content items and one or more labels corresponding to the one or more content items utilizing the one or more assigned classification labels, the search query prompt, and a threshold classification label probability.

In one or more implementations, the act 810 can include identifying a feature extraction component to integrate within a searchable content management system comprising a set of content items, the act 820 can include utilizing the feature extraction component with the set of content items to automatically assign feature extraction data to the set of content items, and the act 830 can include, based on receiving a search query prompt within a content search platform of the searchable content management system, providing for display, within a graphical user interface, one or more content items from the set of content items and one or more feature extraction data corresponding to the one or more content items utilizing the assigned feature extraction data and the search query prompt.

Additionally, the act 810 and the act 820 can include utilizing a feature extraction component integrated within a searchable content management system comprising a set of content items to automatically assign feature extraction data to the set of content items and the act 830 can include, based on receiving a search query prompt within a content search platform of the searchable content management system, provide for display, within a graphical user interface, one or more content items from the set of content items and one or more feature extraction data corresponding to the one or more content items utilizing the assigned feature extraction data and the search query prompt.

In some implementations, the series of acts 800 can include identifying metadata corresponding to the one or more content items, wherein the metadata comprises an identifier for a content item, a file name, and the one or more labels and providing, for display within the graphical user interface, the metadata in relation to the one or more content items. In addition, the series of acts 800 can include modifying metadata associated with a content item to assign a classification label to the content item.

Furthermore, the series of acts 800 can include assigning the one or more labels to the set of content items by utilizing the feature extraction component to determine a label for a content item and modifying metadata associated with the content item based on the determined label. Moreover, the series of acts 800 can include, based on receiving the search query prompt within the content search platform of the searchable content management system, providing, for display within the graphical user interface, feature extraction component data object in relation to the content item to indicate the label and a classification label probability corresponding to the label for the content item. In some instances, the series of acts can include, based on receiving the search query prompt within the content search platform of the searchable content management system, providing, for display within the graphical user interface, a feature extraction component data object in relation to a content item to indicate a classification label and a classification label probability corresponding to the classification label for the content item.

In addition, the series of acts 800 can include deploying the feature extraction component in a live searchable content management system. Moreover, the series of acts 800 can include, based on receiving the search query prompt within the content search platform of the live searchable content management system, providing, for display within a developer graphical user interface in a system testing environment, the one or more content items from the set of content items utilizing the match between the one or more labels (and/or one or more classification labels) and the search query prompt. Furthermore, the series of acts 800 can include, based on receiving the search query prompt within the content search platform of the live searchable content management system, provide, for display within a developer graphical user interface in a system testing environment, the one or more content items from the set of content items utilizing the mapping between the one or more classification labels (from the classification model) to the set of content items.

In some cases, a feature extraction component can include a classification model. Moreover, the series of acts 800 can include utilizing the classification model with the set of content items to automatically map one or more classification labels to the set of content items. For example, the series of acts 800 can include utilizing the classification model to generate image classification labels for image-based content items and/or generate text classification labels for text-based content items.

Furthermore, the series of acts 800 can include, based on deployment of the feature extraction component, utilizing the feature extraction component with the set of content items to determine one or more labels for a content item and generate modified metadata for the content item by backfilling the one or more labels within metadata of the content item. Furthermore, the series of acts 800 can include automatically mapping the one or more classification labels from the classification model to the set of content items by backfilling the one or more classification labels within metadata of content items from the set of content items.

In addition, the series of acts 800 can include identifying a content item function based on the one or more labels assigned to the set of content items. Moreover, the series of acts 800 can include providing, for display within a graphical user interface, the content item function for the one or more content items utilizing the match between the one or more labels and the search query prompt.

Furthermore, the series of acts 800 can include providing, for display within the graphical user interface, one or more selectable search query builder options, wherein the one or more selectable search query builder options comprise selectable label types, selectable search query APIs, or selectable identifier types. In addition, the series of acts 800 can include generating a search query based on the search query prompt and user interactions with the one or more selectable search query builder options. Moreover, the series of acts 800 can include providing, for display within the graphical user interface, the one or more content items based on the one or more labels and the search query.

Additionally, the series of acts 800 can include modifying metadata associated with a content item to assign particular feature extraction data to the content item. For example, the feature extraction component can include a classification model. Moreover, the series of acts 800 can include utilizing the classification model to generate image classification labels for image-based content items (as the feature extraction data) or generate text classification labels for text-based content items (as the feature extraction data).

Moreover, the series of acts 800 can include deploying the feature extraction component on a live searchable content management system. In addition, the series of acts 800 can include, based on receiving the search query prompt within the content search platform of the live searchable content management system, providing, for display within a developer graphical user interface in a system testing environment, the one or more content items from the set of content items utilizing a match between the one or more feature extraction data and the search query prompt.

Furthermore, the series of acts 800 can include, based on receiving the search query prompt within the content search platform of the searchable content management system, providing, for display within the graphical user interface, a feature extraction component data object in relation to a content item to indicate a label and a classification label probability corresponding to the label for the content item as the feature extraction data.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of exemplary computing device 900 that may be configured to perform one or more of the processes described above. One will appreciate that server device(s) 102, the client device 110, and/or the administrator device 114 may comprise one or more computing devices, such as computing device 900. As shown by FIG. 9, computing device 900 can comprise processor 902, memory 904, storage device 906, I/O interface 908, and communication interface 910, which may be communicatively coupled by way of communication infrastructure 912. While an exemplary computing device 900 is shown in FIG. 9, the components illustrated in FIG. 9 are not intended to be limiting. Additional or alternative components may be used in other embodiments. Furthermore, in certain embodiments, computing device 900 can include fewer components than those shown in FIG. 9. Components of computing device 900 shown in FIG. 9 will now be described in additional detail.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage device 906 and decode and execute them. In particular embodiments, processor 902 may include one or more internal caches for data, instructions, or addresses. As an example and not by way of limitation, processor 902 may include one or more instruction caches, one or more data caches, and one or more translation lookaside buffers (TLBs). Instructions in the instruction caches may be copies of instructions in memory 904 or storage device 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 904 may be internal or distributed memory.

Storage device 906 includes storage for storing data or instructions. As an example and not by way of limitation, storage device 906 can comprise a non-transitory storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to computing device 900. In particular embodiments, storage device 906 is non-volatile, solid-state memory. In other embodiments, storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 908 is configured to provide graphical data to a display for presentation to a user. The graphical data may be representative of one or more graphical user interfaces and/or any other graphical content as may serve a particular implementation.

Communication interface 910 can include hardware, software, or both. In any event, communication interface 910 can provide one or more interfaces for communication (such as, for example, packet-based communication) between computing device 900 and one or more other computing devices or networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 912 may include hardware, software, or both that couples components of computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 10 is a schematic diagram illustrating environment 1000 within which one or more embodiments of content management system 104 can be implemented. Content management system 1002 may generate, store, manage, receive, and send digital content (such as digital images and videos). For example, content management system 1002 may send and receive digital content to and from client devices 1006 by way of network 1004. In particular, content management system 1002 can store and manage a collection of digital content. Content management system 1002 can manage the sharing of digital content between computing devices associated with a plurality of users. For instance, content management system 1002 can facilitate a user sharing a digital content with another user of content management system 1002.

In particular, content management system 1002 can manage synchronizing digital content across multiple client devices 1006 associated with one or more users. For example, a user may edit digital content using client device 1006. The content management system 1002 can cause client device 1006 to send the edited digital content to content management system 1002. Content management system 1002 then synchronizes the edited digital content on one or more additional computing devices.

In addition to synchronizing digital content across multiple devices, one or more embodiments of content management system 1002 can provide an efficient storage option for users that have large collections of digital content. For example, content management system 1002 can store a collection of digital content on content management system 1002, while the client device 1006 only stores reduced-sized versions of the digital content. A user can navigate and browse the reduced-sized versions (e.g., a thumbnail of a digital image) of the digital content on client device 1006. In particular, one way in which a user can experience digital content is to browse the reduced-sized versions of the digital content on client device 1006.

Another way in which a user can experience digital content is to select a reduced-size version of digital content to request the full- or high-resolution version of digital content from content management system 1002. In particular, upon a user selecting a reduced-sized version of digital content, client device 1006 sends a request to content management system 1002 requesting the digital content associated with the reduced-sized version of the digital content. Content management system 1002 can respond to the request by sending the digital content to client device 1006. Client device 1006, upon receiving the digital content, can then present the digital content to the user. In this way, a user can have access to large collections of digital content while minimizing the number of resources used on client device 1006.

Client device 1006 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox for iPhone or iPad, Dropbox for Android, etc.), to access and view content over network 1004.

Network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1006 may access content management system 1002.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
identifying a user selection of an additional feature extraction component to integrate within a content search platform of a searchable content management system comprising a set of content items, wherein the content search platform comprises a feature extraction component;
integrating the additional feature extraction component within content search platform;
based on integration of the additional feature extraction component, utilizing the additional feature extraction component with the set of content items to automatically generate one or more labels for the set of content items; and
based on receiving a search query prompt within the content search platform of the searchable content management system, providing, for display within a graphical user interface, one or more content items from the set of content items utilizing a match between the one or more labels and the search query prompt.

2. The computer-implemented method of claim 1, further comprising:
identifying metadata corresponding to the one or more content items, wherein the metadata comprises an identifier for a content item, a file name, and the one or more labels; and
providing, for display within the graphical user interface, the metadata in relation to the one or more content items.

3. The computer-implemented method of claim 1, further comprising providing, for display within a graphical user interface of a client device, a first set of content item results from a content search platform of a searchable content management system utilizing the feature extraction component and a first search query prompt.

4. The computer-implemented method of claim 1, further comprising, based on receiving the search query prompt within the content search platform of the searchable content management system, providing, for display within the graphical user interface, a feature extraction component data object in relation to the content item to indicate the label and a classification label probability corresponding to the label for the content item.

5. The computer-implemented method of claim 1, further comprising:
integrating the additional feature extraction component on a live searchable content management system; and
based on receiving the search query prompt within the content search platform of the live searchable content management system, providing, for display within a developer graphical user interface in a system testing environment, the one or more content items from the set of content items utilizing the match between the one or more labels and the search query prompt.

6. The computer-implemented method of claim 1, wherein the additional feature extraction component comprises a classification model, the computer-implemented method further comprising utilizing the classification model with the set of content items to automatically map one or more classification labels to the set of content items.

7. The computer-implemented method of claim 6, further comprising utilizing the classification model to:
generate image classification labels for image-based content items; or
generate text classification labels for text-based content items.

8. The computer-implemented method of claim 1, further comprising, based on integration of the additional feature extraction component, utilizing the additional feature extraction component with the set of content items to:
determine one or more labels for a content item; and
generate modified metadata for the content item by backfilling the one or more labels within metadata of the content item.

9. The computer-implemented method of claim 1, further comprising identifying a content item function based on the one or more labels assigned to the set of content items.

10. The computer-implemented method of claim 1, further comprising:
providing, for display within the graphical user interface, a selectable option to select the additional feature extraction component; and
in response to a selection of the selectable option, integrating the additional feature extraction component within content search platform.

11. A non-transitory computer-readable medium storing instructions that, when executed by at least one processor, cause a computing device to:
utilizing a feature extraction component integrated in a searchable content management system, the feature extraction component enabling a first classification model to output classification labels for a set of content items within the searchable content management system to automatically map one or more classification labels from the first classification model to the set of content items;
utilizing an additional feature extraction component integrated in the searchable content management system, the additional feature extraction component enabling a second classification model to output additional classification labels for the set of content items within the searchable content management system to automatically map one or more additional classification labels from the second classification model to the set of content items; and
based on receiving a search query prompt within a content search platform of the searchable content management system, provide for display, within a graphical user interface, one or more content items from the set of content items utilizing a match between the search query prompt and the one or more classification labels or the one or more additional classification labels.

12. The non-transitory computer-readable medium of claim 11, further comprising instructions that, when executed by the at least one processor, cause the computing device to, based on receiving the search query prompt within the content search platform of the searchable content management system, providing, for display within the graphical user interface, a feature extraction component data object in relation to a content item to indicate a classification label and a classification label probability corresponding to a classification label for the content item.

13. The non-transitory computer-readable medium of claim 11, further comprising instructions that, when executed by the at least one processor, cause the computing device to:
integrate the feature extraction component in a live searchable content management system; and
based on receiving the search query prompt within the content search platform of the live searchable content management system, provide, for display within a developer graphical user interface in a system testing environment, the one or more content items from the set of content items utilizing a mapping between the one or more classification labels from the first classification model to the set of content items.

14. The non-transitory computer-readable medium of claim 11, further comprising instructions that, when executed by the at least one processor, cause the computing device to utilize the first classification model to:
generate image classification labels for image-based content items; or
generate text classification labels for text-based content items.

15. The non-transitory computer-readable medium of claim 11, further comprising instructions that, when executed by the at least one processor, cause the computing device to automatically map the one or more classification labels from the first classification model to the set of content items by backfilling the one or more classification labels within metadata of content items from the set of content items.

16. A system comprising:
at least one processor; and
at least one non-transitory computer-readable storage medium storing instructions that, when executed by the at least one processor, cause the system to:
utilize multiple feature extraction components integrated within a searchable content management system comprising a set of content items to automatically assign feature extraction data to the set of content items; and
based on receiving a search query prompt within a content search platform of the searchable content management system, provide for display, within a graphical user interface, one or more content items from the set of content items and one or more feature extraction data corresponding to the one or more content items utilizing the assigned feature extraction data and the search query prompt.

17. The system of claim 16, further comprising instructions that, when executed by the at least one processor, cause the system to modify metadata associated with a content item to assign particular feature extraction data to the content item.

18. The system of claim 16, further comprising instructions that, when executed by the at least one processor, cause the system to:
integrate the multiple feature extraction components in a live searchable content management system; and
based on receiving the search query prompt within the content search platform of the live searchable content management system, provide, for display within a developer graphical user interface in a system testing environment, the one or more content items from the set of content items utilizing a match between the one or more feature extraction data and the search query prompt.

19. The system of claim 16, wherein the multiple feature extraction components comprise classification models and further comprising instructions that, when executed by the at least one processor, cause the system to utilize the classification models to:
generate image classification labels for image-based content items as the feature extraction data; or
generate text classification labels for text-based content items as the feature extraction data.

20. The system of claim 16, further comprising instructions that, when executed by the at least one processor, cause the system to, based on receiving the search query prompt within the content search platform of the searchable content management system, provide, for display within the graphical user interface, a feature extraction component data object in relation to a content item to indicate a label and a classification label probability corresponding to the label for the content item as the feature extraction data.
